(19) United States
(12) Patent Application Publication
(10) Pub. No.: US 2008/0000579 A1
(43) Pub. Date: Jan. 3, 2008

(54) Procedure and Equipment for Decoration of Objects by Sublimation Inks

(76) Inventor: Giovanni Bortolato, Carate Brianza MI (IT)

Correspondence Address: JACOBSON HOLMAN PLLC, 400 SEVENTH STREET N.W., SUITE 600, WASHINGTON, DC, 20004, US

(21) Appl. No.: 11/667,660

(22) PCT Filed: Nov. 8, 2005
(86) PCT No.: PCT/EP05/11923

§ 371 Date: May 14, 2007

(51) Int. Cl. B41M 5/025; B41F 16/00

(52) U.S. Cl. 156/235; 156/583.1

(57) ABSTRACT

A procedure for decoration by sublimation of various objects and in particular of rusticated metal sheet comprises the steps of heating the object to a first temperature lower than that of sublimation of the sublimable inks used, positioning on the object surface to be decorated a sheet with the sublimable inks, creating a vacuum between the sheet and the object to cause adherence of the sheet to the surface of the object, and then completion of heating to reach the sublimation temperature of the inks and transfer of the decoration to the surface of the object. In particular, the sheet is thermoformable at the first temperature to adapt itself better to the object before reaching the sublimation temperature. There is also described equipment (10, 110) with a work zone (14, 114) surrounded by a frame (16, 116) bearing the sheet for covering the object and surmounted by heating lamps (20, 120).

This invention relates to a procedure and equipment for decoration of various objects and in particular rusticated metal sheets for the construction of doors having panels in relief, extruded parts or thick tops.

In the field of decoration by the process of sublimation of inks reproducing the drawing to be transferred, there are many different types of system that allow realizing the decoration of rusticated door, extruded frames or fusion details or molded parts or any kind or shape.

For rusticated metal sheets the present technique consists of decorating the flat metal sheet (previously painted) with hot flat presses and subsequently performing the rustication by means of mechanical presses. Unfortunately, mechanical molding on a part already painted causes cracks in the paint which, even if invisible to the naked eye, favor corrosion due to atmospheric agents that insert themselves easily into the cracks of the paint and reach the metal surface.

For small previously painted details such as metal doors, loading platforms for boards or other thin and small metal details, the prior art consists on the other hand of the use of a thermoformable film (in general of polyvinyl alcohol) that is preheated to a temperature of approximately 100° C. and then, through the vacuum, made to adhere to the cold part so that the film takes on the shape of the part. Then the whole is taken to the sublimation temperature without need of vacuum.

This procedure is valid for light details that reach sublimation temperature of approximately 190° C. in a short time but does not work when applied to details of great thermal capacity such as to require lengthy times (for example more than five minutes) before reaching sublimation temperature. The need to have the film in contact with the part for a long time, in addition to stressing the film, generates a bad decoration because the inks held for long in a gaseous state spread in the substrate (paint) and generate a drawing with poor definition.

Therefore the known techniques are distinguished by resulting low productivity and low final quality of the part.

The purpose of this invention is to remedy the above mentioned shortcomings of the prior art by making available a procedure and a device for decoration by sublimation allowing realization of details even of rusticated metal sheet or parts with high thermal capacity rapidly and with reduced or null manual intervention.

In view of this purpose it was sought to provide in accordance with this invention a procedure for decoration by sublimation of various objects and in particular of rusticated metal sheet comprising the steps of heating the object to a first temperature lower than that of sublimation of the sublimable inks used, positioning on the object surface to be decorated a sheet with surface towards the object bearing the decoration realized by said sublimable inks, creating a vacuum between the sheet and the object to cause adherence of the sheet to the surface of the object, completion of heating to reach the sublimation temperature of the inks and transfer of the decoration to the surface of the object while maintaining the vacuum.

Again in accordance with this invention it was sought to realize equipment for the realization of a procedure for decoration of objects by sublimation of inks on the side of a sheet placed in contact with the object and comprising a working zone with means of heating to reach the sublimation temperature, a frame bearing an inked sheet to arrange it sealed on the object to be decorated, and means of suction to produce a vacuum between the sheet and the object to make the sheet adhere with the inked side to the object surface.

To clarify the explanation of the innovative principles of this invention and its advantages compared with the prior art there is described below with the aid of the annexed drawings possible embodiments thereof by way of non-limiting example applying said principles. In the drawings:

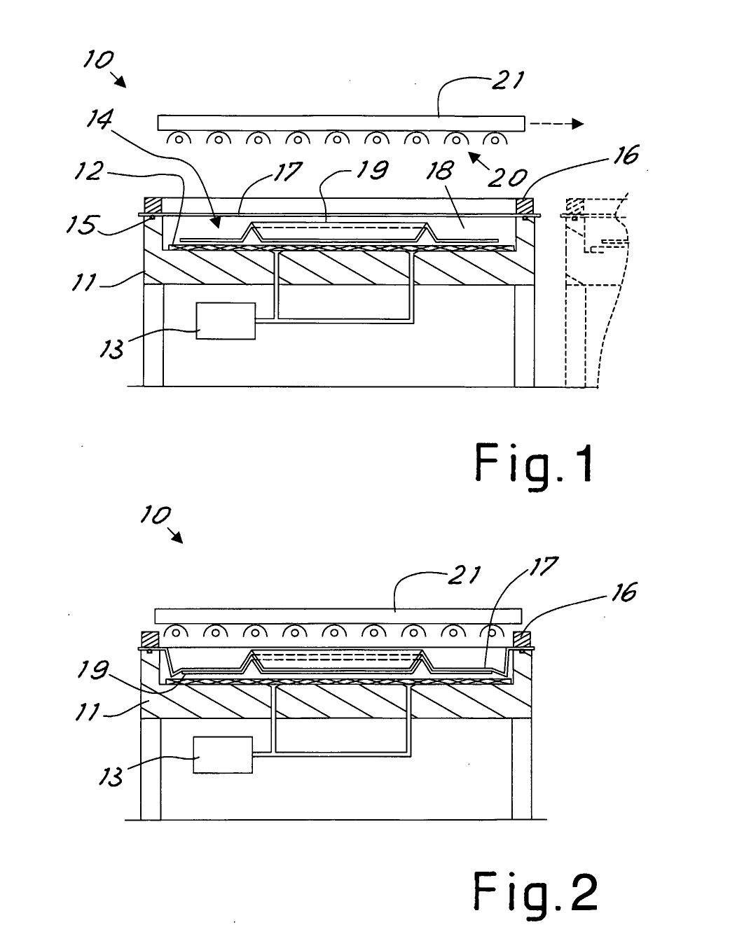

FIGS. 1 and 2 show diagrammatically a side cross section of a device in accordance with this invention in various operational steps,

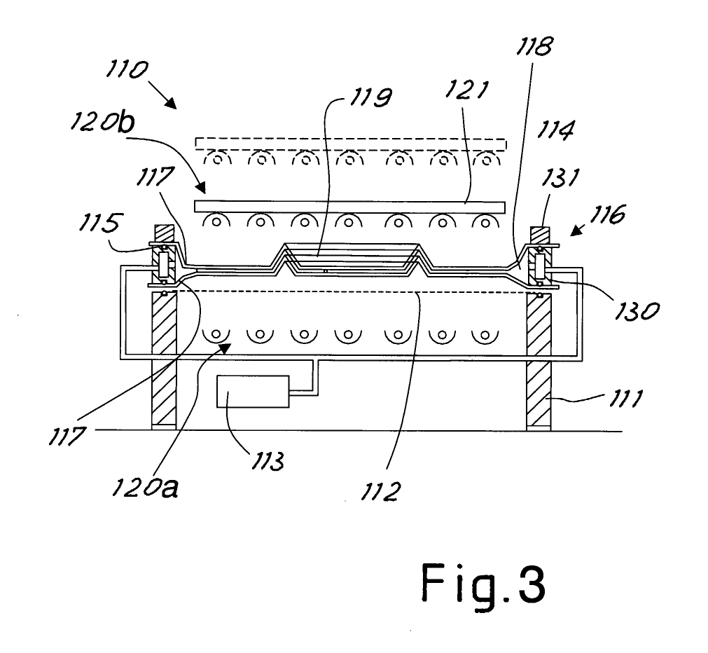

FIG. 3 shows a diagrammatic view of a variant embodiment of the device of the above figures for simultaneous decoration of two opposite sides of an object, and

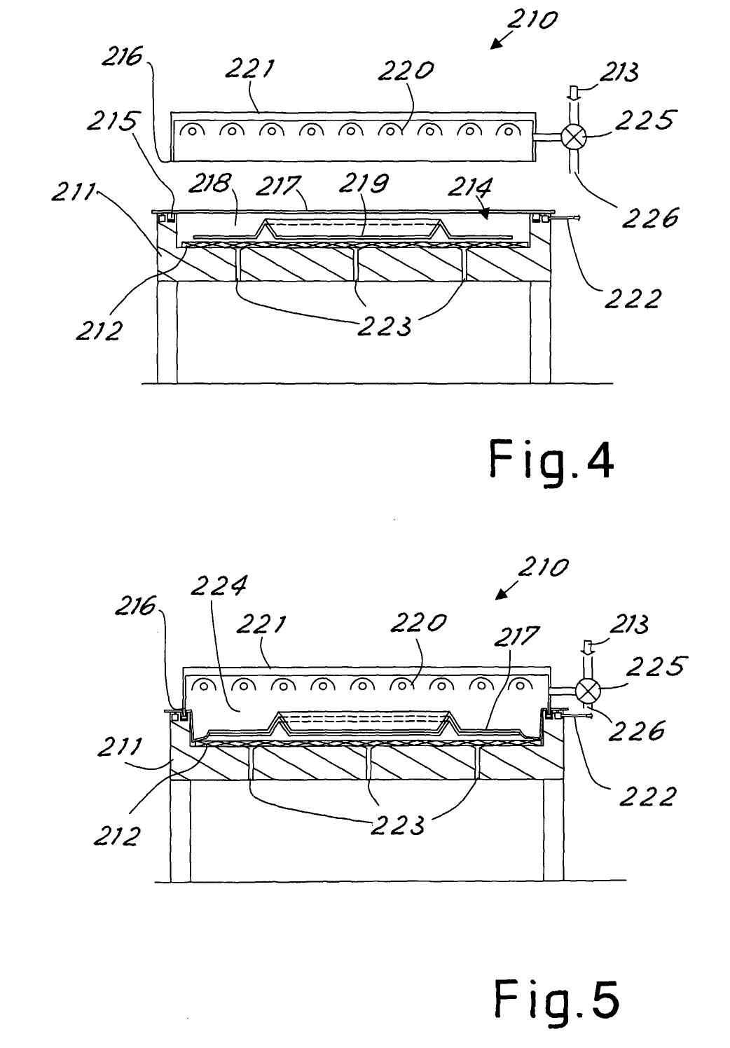

FIGS. 4 and 5 show diagrammatic views of another variant of the device.

With reference to the figures, FIG. 1 shows diagrammatically a device in accordance with this invention designated as a whole by reference number 10 in a first operational step. The device comprises a work top 11 containing a support plane with suction realized advantageously of spongy material 12 with open pores and resistant to the temperatures reached during operation of the device and connected to a suction system 13.

The suction plane 12 is housed in a work seat or zone 14 surrounded by a sealing gasket 15 for support of an upper frame with molding 16 with interposition of or bearing a decoration film or sheet 17 with sublimable inks in such a manner as to create a sealed chamber 18 between the suction plane and the film. The part 19 to be decorated is housed in the chamber 18.

Above the work top there are heating means 20 advantageously with infrared lamps that are preferably positioned on a frame 21 movable in relation to the work top to allow moving aside the heating system during access to the seat 14 and positioning of the frame with the film. As clarified below, the heating means are applicable selectively for heating of the object to a first temperature below the sublimation temperature and for heating to the sublimation temperature the object covered by the sheet.

It was found that advantageously to have a decoration of better quality the film used should become plastic (extensible on all sides) at a temperature variable between 60° C. (advantageously 80° C.) and 140° C. and should resist without melting at least up to a slightly higher than the sublimation temperature of the inks used. For example, with sublimation temperature of 190° C. the film should advantageously resist up to a temperature around 200° C.

In addition, the surface of the film on the inked side has preferably a roughness (obtained also by flocking, filling with grains of inert material, embossing et cetera) such as to allow passage of air between the film and the surface to which it will be made to adhere so as to be able to evacuate the gasses that form during heating.

In accordance with this invention after having rested the part to be decorated in the seat 14, it is brought with the infrareds 20 to a temperature (for example between 60° C. and 150° C., advantageously around 140° C.) near but less than the sublimation temperature of the inks used. After this the thermoformable film 17 is positioned and, by closing of the frame 16 on the edge of the seat 14, a sealed chamber is created between the film and the suction plane.

By operating the suction means 13, the vacuum created in the chamber takes the film into contact with the hot part as shown in FIG. 2. Being a thermoformable film, it dilates and goes to adhere on the surface of the part. After adhesion, the heating means 20 are again operated to take the film-covered part to the sublimation temperature, for example approximately 190° C.

In this final step, vacuum suction is maintained between the work top and the film in order to eliminate any gasses that form during heating and that would cause the film to detach from the part surface.

After decoration, the frame can be opened and the part removed. The device is then ready for a new decoration cycle.

It is now clear that, with a system in accordance with this invention, decoration can be obtained of varied objects and in particular of rusticated metal sheets such as those used for constructing doors with panels in relief, moldings, plates of metal or composite materials, fusions, and other objects characterized also by higher thermal inertia.

The height of the object on the suction plane will be limited only by the depth of the seat and by the thermoplastic deformability of the film.

A possible embodiment of a machine applying the principles of this invention is described above but many other technical variants can be realized all traceable back to the principles of this invention.

FIG. 3 shows an embodiment variant in which two opposite sides of the object are decorated simultaneously.

In this embodiment designated as a whole by reference number 110 the work top 111 comprises a support plane 112 under which are arranged heating means 120a advantageously infrared. The support plane 112 is realized to allow heating of anything arranged above it. For example the plane 112 can be made of a metallic network or a material transparent to infrareds. There is thus a work zone 114.

A frame structure 116 is designed to be arranged around the work zone and consists of two superimposed members 130 and 131 to receive two inked films 117 superimposed and spaced. Appropriate gaskets ensure seal between the various superimposed parts. Suction means 113 are connected to the molding member 130 that is located between the two films so as to be able to create a vacuum in the chamber 118 delimited by the film. In the chamber is placed the member 119 to be decorated on both sides. Above the chamber there are other infrared heating means 120b advantageously associated with handling means 121 to be able to move aside (as shown in broken lines in FIG. 3) for operations of positioning the film, the part to be decorated and the frame.

In use, the lower film is first positioned on the plane 112, then the part to be decorated is placed and the moldings 116 are arranged with the second film. While irradiation from the lower part takes place through the film the upper one can be done before positioning of the upper film. This allows maintaining the advantages of this invention especially if the shape of the part to be decorated requires more distension of the upper film than the lower film.

FIG. 4 shows a variant embodiment designated as a whole by reference number 210 that uses overpressure above the film to create vacuum in the chamber.

A work top 211 contains a support plane of spongy material 212 with open pores resistant to high temperature and connected to discharges 223 into the atmosphere. Peripherally there is a seat for an upper hood 221 with sealing gaskets 215 so as to create an airtight chamber 218 between the hood 221 and the film 217. There may also be provided a suction system 222 for the seal of the film 217 on the work top 211 by the vacuum. The pressure seal hood 221 can be translatable vertically and is constructed in such a manner as to create a sealed chamber 224 between the hood and the decoration film as may be seen in FIG. 5. An infrared ray heating system 220 is positioned on the upper hood.

A pressure source 213 is connected to the chamber 224 through a valve 225 that can also discharge into 226. In the cross section of FIG. 5 it can be seen that the film after being preheated to a temperature of approximately 80° C. with the infrareds 220 is made to adhere to the part surface 219 by the pressure created by the external circuit 213 and kept under pressure (advantageously between 0.1 bar and 0.5 bar) until the part reaches the sublimation temperature (between 180° C. and 200° C. i.e. approximately 190° C.).

Before opening the pressurized hood, the air delivery 213 is closed by means of valve 225 and the pressure is discharged to the exterior by means of the discharge 226.

It is now clear that the preset purposes have been achieved. A considerable advantage of the procedure and equipment in accordance with this invention is that during the preheating step, carried out before deposition of the single film on the upper film, any gasses present in the porosity of the paint (for example even a simple water vapor) are evacuated in advance with considerable improvement in the quality of the decoration.

In addition, the heating times of the sublimation step are considerably reduced and allow obtaining quality of the decoration with high contrast and definition.

Another advantage of the procedure and equipment in accordance with this invention is that, due to the effect of temperature on the part, the film remains a long time in the softening step and grows longer on all sides and penetrates into all the hollows on the piece.

There is also the possibility of treating large thick objects to obtain a decoration with the quality of thinner parts since the preheating performed only for the former brings near the times of the sublimation step of the two types of manufactured article.

In addition, it is clear how manual operations linked to the operator's skills in avoiding prior art shortcomings are reduced.

Thanks to the special system of adaptation of the film on the hot object there is better quality of the decoration of the angles, small-radius edges, hollows even of great depth (even up to 150 mm approximately) without occurrence of creases in the film.

In addition there is uniform pressure between the film and the part surface such as to allow better penetration of the inks over the entire thickness of the paint (for example polyester, acrylic, polyurethane or various mixtures). Uniform pressure also allows treating large objects.

The machines in accordance with this invention also have low power consumption since the infrared lamps during part preheating do not undergo insulation due to film thickness. In addition, by using lamps with fast starting and switching off, they are used only for the time necessary for direct heating of the part in the first step (longer) and of the part covered with film in the second step (shorter). This time is variable for step one from 1 to 10 minutes approximately and for step two from 1 to 5 minutes approximately.

With the procedure and equipment in accordance with this invention decoration by sublimation of three-dimensional objects is possible and in particular rusticated metal sheets or parts with great thermal capacity such as tiles, pressure die-casting, fusions or molded parts in general.

The procedure and equipment in accordance with this invention allow realization of a finishing operation completely automatic with high definition with no chance of errors due to the skill of the workers.

Special films with high surface roughness or treatments (flocking) such as to allow air suction (necessary for vacuum machines) are not necessary.

The film, as it can have a smooth surface on the side where the ink is deposited, allows high drawing definition. There is also less cost of the decoration film since it can be a standard product.

Some advantages of the procedure and equipment in accordance with this invention can be summarized as follows:
reduced costs thanks to automation of the system (less labor used) and less film cost,
better quality of the decoration of the angles, small-radius edges, hollows even of great depth (100 mm approximately) without occurrence of creases in the film,
uniform pressure between the film and the surface so as to allow better penetration of the inks over the entire thickness of the paint (polyester, acrylic, polyurethane or various mixtures),
use of flat surface film with high-definition drawings, and
low power consumption since the infrared lamps with fast lighting and shutting off are used only for the time necessary for heating of the film and the part. This time is variable from 1 to 5 minutes. Practically all of the heat generated by the lamps is used for heating the part, contrary to hot air systems which, in addition to always remaining lit, require approximately double the consumption and heating times.

Naturally the above description of an embodiment applying the innovative principles of this invention is given by way of non-limiting example of said principles within the scope of the exclusive right claimed here. Many variants can be conceived all contained in this invention.

For example, a device such as that of FIG. 3 can be used even to realize the decoration on only one side by inserting in place of the lower film a rigid plane to support the part so as to proceed as in the device of FIG. 1. Although the suction through a sucking plane is preferred for one-side decoration, even in the device of FIG. 1 it is possible to use a side suction system instead of with a suction plane.

The film can be placed on the plane and then removed at the end of processing by known automatic or semiautomatic systems of unwinding of rewinding. In addition, the work planes can also have several positions (for example two or three positions) as shown diagrammatically in broken lines in FIG. 1 and the heating lamps can translate relatively sidewise above the various working positions, and the work positions or lamps can be moved.

In the case of two films, instead of using vacuum as in FIG. 3 pressure can be used as in FIG. 4 on both external sides.

1. A procedure for decoration by sublimation of various objects and in particular of rusticated metal sheet comprising the following steps:
heating the object to a first temperature lower than that of sublimation of the sublimable inks used,
positioning on the object surface to be decorated a sheet with surface towards the object bearing the decoration realized by said sublimable inks,
creating a pressure difference between the sheet and the object compared with the opposite side of the sheet to cause adherence of the sheet to the object surface, and
completion of heating to reach the sublimation temperature of the inks and transfer of the decoration to the surface of the object while maintaining the vacuum.

2. The procedure in accordance with claim 1 in which the first temperature is between 60° C. and 150° C. and in particular between 80° C. and 140° C.

3. The procedure in accordance with claim 1 in which the sheet is realized thermoformable at the first temperature.

4. The procedure in accordance with claim 1 in which the object to be decorated is positioned between two inked sheets with the inked sides turned towards the part so as to make the decoration simultaneously on the two sides and the vacuum is created between the two sheets.

5. The procedure in accordance with claim 1 characterized in that the heating takes place by means of infrared lamps.

6. The procedure in accordance with claim 4 characterized in that the heating takes place by means of infrared lamps positioned on both sides of the object.

7. The procedure in accordance with claim 1 characterized in that the pressure difference is obtained by creating a vacuum between the sheet and the object.

8. The procedure in accordance with claim 7 characterized in that the object is placed on a work top with suction zone and the sheet is blocked and sealed on the top around the object and the suction zone for creating said vacuum between the object and the sheet.

9. The procedure in accordance with claim 1 characterized in that the pressure difference is obtained by creating pressure on the sheet side opposite the object.

10. An equipment for realization of a procedure for decoration of objects by means of sublimation of inks located on the side of a sheet placed in contact with the object and comprising a work zone with heating means for reaching the sublimation temperature, a frame bearing an inked sheet to arrange it sealed above the object to be decorated, and means for production of a pressure difference between the sheet and the object compared with the opposite side of the sheet to cause adhesion of the sheet with the inked side to the surface of the object.

11. The equipment in accordance with claim 10 characterized in that the heating means can be operated selectively for heating of the object to a first temperature lower than the sublimation temperature and for heating of the object covered by the sheet to the sublimation temperature.

12. The equipment in accordance with claim 10 characterized in that it comprises a work top designed to support the object to be decorated and on which is arranged sealed and removable a frame for support of the inked sheet for covering the object on the work top with the sheet and enclosing it in a sealed manner.

13. The equipment in accordance with claim 12 characterized in that the work top comprises suction zones for creating the vacuum between the sheet and the work top.

14. The equipment in accordance with claim 12 characterized in that the frame supports in a sealed manner two parallel sheets with the object between.

15. The equipment in accordance with claim 14 characterized in that the frame is made up of two moldings superimposed to imprison the edges of the parallel sheets.

16. The equipment in accordance with claim 14 characterized in that the suction means suck through the frame in the space between the two sheets.

17. The equipment in accordance with claim 10 characterized in that the heating means comprise infrared lamps.

18. The equipment in accordance with claim 12 characterized in that the heating means are arranged to heat above and below the work top.

19. The equipment in accordance with claim 10 characterized in that the heating means are movable relative to the work zone to be approachable to or withdrawable from said zone.

20. The equipment in accordance with claim 19 characterized in that the heating means translate relatively laterally above several work zones.

21. The equipment in accordance with claim 10 characterized in that the production means of the pressure difference comprise means of creating overpressure above the film to push the film against the object.

22. The equipment in accordance with claim 21 characterized in that the overpressure creation means blow into a hood arranged sealed above the film.

23. The equipment in accordance with claim 22 characterized in that the hood imprisons peripherally the film on a frame edge surrounding the object.

24. The equipment in accordance with claim 12 characterized in that the work top comprises passages for evacuation of the air between the sheet and the object.
